(19) United States
(12) Patent Application Publication
(10) Pub. No.: US 2021/0283818 A1
(43) Pub. Date: Sep. 16, 2021

(54) Method of Manufacturing a Plastic Canister

(71) Applicant: Dr. Ing. W. Frohn GmbH & Co. KG, Oberhaching (DE)

(72) Inventor: Eric Frohn, Grünwald (DE)

(73) Assignee: Dr. Ing. W. Frohn GmbH & Co. KG, Oberhaching (DE)

(21) Appl. No.: 17/201,362

(22) Filed: Mar. 15, 2021

(30) Foreign Application Priority Data
Mar. 16, 2020 (EP) EP20163220.5

(51) Int. Cl. B29C 49/04; B29C 49/42; B29C 49/58; B29C 49/30

(52) U.S. Cl. CPC B29C 49/04; B29C 49/4205; B29C 49/58; B29C 49/30; B29K 2105/258; B29C 2049/044; B29C 2049/5844; B29C 2793/0027; B29C 49/4242

(57) ABSTRACT

Disclosed is a method for manufacturing a container made of plastic, including the following steps: continuously extruding a hose, positioning an opened blow mold around the hose, so that the hose is arranged between the two blow mold halves, closing a hose gripper arranged at the blow mold to clamp the hose and simultaneously keeping the hose open at its upper side to form an inlet opening, separating the hose above the hose gripper to form the preform, horizontally moving the blow mold together with the preform hanging therein and held by the hose gripper into a blowing position, moving a blow mandrel assembly from above into the inlet opening of the preform, closing the blow mold halves, and inflating the preform in the blow mold to form a container.

The invention relates to a method for manufacturing a container made of plastic. Further, the invention relates to a blow mold for manufacturing a plastic container.

A previously known container is shown in U.S. Pat. No. 5,538,165 as an example. The container disclosed therein is a plastic container with a venting channel formed on the upper wall and extending vertically inside the pouring spout to enable gurgle-free emptying. The container disclosed therein is manufactured by a extrusion blow molding process using an accumulator blow head. In this process, the hose, which is extruded and open at the bottom, moves between the opened blow mold halves over the blow mandrel positioned thereunder. Before closing the blow mold halves, the blow mandrel can then be moved horizontally within the plasticized plastic hose to the desired, mainly asymmetrical position, in which the pouring opening of the container is to be formed. Then, the blow mold closes and the plasticized plastic hose is inflated inside the blow mold. A disadvantage of this method is however that the extrusion of the hose cannot run continuously during the inflation process, as the blow mold together with the blow mandrel is arranged directly under the outlet of the accumulator blow head during the entire production of the container and thus obstructs the further outpouring of a new hose. The duration of the hose outpouring is thus always added to the inflation duration of the container, which extends the total production time of the container.

The aforementioned container with a venting channel extending vertically inside the spout, as well as a container with an internal thread in the spout, cannot be manufactured in the faster blowing method of continuous extrusion. In this method, the extruded hose is outpoured continuously. Once the required hose length is reached, the opened blow mold halves move in front of and behind the hose, close and clamp the hose, to move back into a neighboring position with the clamped hose. A corresponding blow mandrel then moves vertically from above into a in the blow mold, divides the clamped hose, thus forms the container spout and inflates the hose. When the hose is divided, surplus plasticized material is pushed down into the interior of the produced container by the vertically penetrating mandrel, which causes closure of the venting channel formed in the spout, or damages the thread passages in case of internal threads.

It is the object of the present invention to provide a method of manufacturing a blow-molded plastic container with a venting channel, which extends vertically within the spout, or a spout with an internal thread, which enables such a container to be manufactured quickly and easily.

The object is solved by the features of the independent claims. The dependent claims have advantageous embodiments of the invention.

The method of the invention comprises at least the following steps in the given order:

a) Continuous extrusion of a hose made of plastic. For this purpose, plastic granules are usually plasticized and pressed through a blow head. The result is a continuously fed hose that hangs downward. The continuous extrusion takes place preferably without interruption, so that the hose continues to be extruded while the hose segments required for production are removed and while they are inflated.

b) During extrusion of the hose, an opened blow mold is positioned around the hose. This blow mold comprises two blow mold halves. The mold cavity for a container is formed in these blow mold halves. The opened blow mold is positioned around the hose below the blow head in such a way that the hose is arranged between the two blow mold halves.

c) In the next step, the blow mold is not closed as usual. Instead, a hose gripper is provided at the blow mold. This hose gripper is formed to clamp the hose and at the same time hold the hose open on its upper side. For this, the hose gripper is arranged at the upper side of the blow mold and movable together with the blow mold. To clamp the hose, components of the hose gripper are movable relative to the two blow mold halves, so that the hose can be clamped with the hose gripper without closing the blow mold halves. The hose gripper does not clamp the hose over its entire cross-section, but only at the side, so that the hose remains open at its top. This opening is referred to as the “inlet opening”, as the blow assembly later enters through this opening.

d) In the next step, the hose is separated above the hose gripper, so that the preform is separated from the continuously extruding hose. After the separation, the preform hangs in the opened blow mold; held by the closed hose gripper. The separation or rather the separating device is configured in such a way that the hose is simultaneously separated and closed above the cutoff point, so that the next preform is closed at its bottom side.

e) As the hose is continuously extruded further and thus spreads downwards, the blow mold together with the preform hanging therein is moved horizontally into a so-called “blowing position”. In this blowing position, the blow mold is arranged to be outside the area under the blow head.

f) Initially the blow mold is kept opened in the blowing position. The blow mandrel is now inserted from above into the inlet opening of the preform. This shows a significant advantage of the invention: when there is no hose gripper to hold the preform open with the inlet opening, the blow mold will be closed at this moment in order to fix the preform and move the preform into the blowing position. When the blow assembly enters the spout opening of the blow mold from above, the material (plastic) would be pushed downwards due to this relatively narrow opening. This would result in an accumulation of material in the lower area of the spout. This is particularly disadvantageous when forming a venting channel in the spout by means of a relatively small ancillary mandrel. This relatively small ancillary mandrel for forming the venting channel with a relatively small diameter could lead to significant constriction or closure of the venting channel in the case of pushing the material. Similarly, this could be disadvantageous when producing an opening with an internal thread, as the thread passages can be damaged in this way. In order to avoid these disadvantages, according to present invention, the blow mold is not initially closed, but the preform is only held by means of the hose gripper. In this way, the inlet opening remains on the upper side of the hose, which is considerably larger than the blow mold opening forming the spout. Preferably, the inlet opening comprises at least twice the area of the blow mold opening forming the spout. This allows the blow mandrel to enter without contact with the preform.

g) In the following step, when the blow mandrel has already entered the inlet opening of the preform, the blow mold is closed completely.

h) When the blow mold halves are completely closed, the preform is inflated in the blow mold to form a container. For this purpose, compressed air is blown into the inside of the preform via the blow mandrel, so that the hose is arranged against the inside of the mold cavity in the blow mold.

In following steps, the blow mold can be opened and the container can be removed in the usual way.

During all these method steps, the hose is further extruded at the extrusion head, so that, after the container is removed, the opened blow mold is moved again horizontally under the hose head in order to grip the next preform with the hose gripper. This results in a continuous method, in which an extrusion is carried out continuously, enabling containers to be produced as quickly and reliably as possible.

The “opened” blow mold or rather “opened” blow mold halves described here denote a state of the blow mold, in which the blow mold halves are at least not completely closed. Preferably, the two blow mold halves are at least far enough apart from each other to allow the preform to hang between them with a sufficiently large inlet opening.

The container produced by the method of the invention comprises preferably the following features. Preferably, the container comprises a spout for pouring in and out. Preferably, a venting channel protrudes into this spout. The venting channel further preferably comprises a horizontal portion and a vertical portion. The vertical portion of the venting channel preferably extends into the spout and preferably ends under the upper end of the spout.

This results in two openings in the spout, namely a main opening, through which liquid can be poured into and out of an inner space of the container, and a venting opening formed by the vertical portion of the venting channel. The venting channel leads to a rear portion of the inner space through the horizontal portion. The function of the venting channel is described in detail in U.S. Pat. No. 5,538,165.

The blow mandrel assembly used in the method preferably comprises a main blow mandrel and an ancillary blow mandrel. A squeezing edge gap is preferably arranged between the main blow mandrel and the ancillary blow mandrel. The two blow mold halves comprise a squeezing edge. When the blow mold is closed, the two opposite squeezing edges of the two blow mold halves protrude into this squeezing edge gap between the main blow mandrel and the ancillary blow mandrel, so that an inner channel wall of the venting channel is formed in the area of the spout. However, this squeezing to form the inner channel wall takes place only after the blow mandrel assembly is already in place in the preform, so that during the closing of the two blow mold halves, both the main blow mandrel and the ancillary blow mandrel are arranged to form the main opening and the vent opening in the spout of the container.

The hose gripper comprises gripping elements. Gripping elements at the hose gripper are the parts that are movable relative to the blow mold halves in order to clamp the hose between the gripping elements. Accordingly, there is at least one gripping element on each of the blow mold halves. The respective gripping element is movably guided on its blow mold half, so that the gripping elements are movable towards each other in the mold closing direction of the blow mold.

Gripping areas are defined at the gripping elements, which form the actual contact with the hose. The particular gripping area comprises two opposing, complementary surfaces of two gripping elements. Preferably the hose gripper comprises at least two gripping areas spaced apart from each other. The hose is clamped at each gripping area. The two gripping areas are spaced apart from each other, so that the described inlet opening remains between the two gripping areas. Preferably, it is arranged that the gripping elements are spring-loaded in the mold closing direction by means of springs. In particular, at least one spring is arranged per gripping element, which in the tensioned state presses the gripping element in the direction of the hose, so that the hose can be clamped. To hold the gripping elements in the opened, i.e. retracted position and thus to hold the gripping elements against the spring force, at least one holding device is arranged preferably on each blow mold half. This holding device can hold the corresponding gripping element or can in other ways block the relaxation of the spring, so that the hose gripper does not close. The holding devices preferably work hydraulically or pneumatically, for example as hydraulic cylinders or pneumatic cylinders. The springs can be coil springs or other energy accumulators, for example also hydraulic or pneumatic energy accumulators.

According to the inventive method, the springs are tensioned, when the blow mold halves close. This is easy to do, since the gripping elements are closed anyway and clamp the preform, before the blow mold halves are closed. When the blow mold halves move towards each other, the springs are automatically tensioned again. When the blow mold halves are subsequently opened, the springs are held in the tensioned state, preferably through the above-mentioned holding devices.

In one variant, each gripping element is in two parts. The two parts of the respective gripping element are movable in a horizontal direction perpendicular to the mold closing direction. This makes it possible for the two gripping areas, after the clamping, to be moved towards each other for deforming the inlet opening. When the preform is clamped by the hose gripper, an essentially oval inlet opening is formed between the two gripping areas. By moving the two gripping areas towards each other, this oval form can be changed to a rounder form. This can result in a form of the inlet opening that allows an optimal insertion of the blow assembly.

Further, preferably compressed air is injected into the preform for pre-blowing before the blow mold halves are closed, for example during the horizontal movement of the blow mold to the blowing position or in the blowing position. This pre-blowing can also be referred to as “prestretching”. Particularly preferably, there is at least one compressed air nozzle at the hose gripper, in particular at one of the gripping elements, via which air can be injected for pre-blowing the preform even before the blow mold halves are closed.

Further, preferably the preform is inflated beyond the inner mold dimension of the blow mold during pre-blowing. By the time the blow mold is closed, the preform reorients itself a little, so that it fits into the mold cavity.

Further, in the method of the invention, a movement of the blow mandrel assembly can take place in the horizontal direction after entering into the inlet opening and before closing of the blow mold halves. This makes it possible, for example, for the spout of the container to be arranged very far on the side.

Further, it is preferably arranged that the ancillary mandrel of the blow mandrel assembly comprises at least one inclined-arranged compressed air outlet at its underside. Through this compressed air outlet, when the container is inflated, the compressed air can be blown not only vertically downwards but also laterally onto the material (plastic). This makes it possible to blow away material that was pressed into the venting channel in order to support the molding process, when the two blow mold halves are closed.

The invention further comprises a blow mold for producing a container. In particular, the container is the one already described above. Preferably, the blow mold is arranged for carrying out the method. It is understood that not only the blow mold, but also other elements, preferably the blow head, for extruding the hose, can be arranged for carrying out the method.

The blow mold of the invention comprises two blow mold halves, which, with their mold cavity, can form the container. The two blow mold halves can comprise sliders to form the geometry of the desired container.

The hose gripper described above with its two gripping elements is arranged on the blow mold halves. At least one gripping element is arranged on each blow mold half.

The gripping elements are movable parallel to the mold closing direction and relative to the respective blow mold halves, so that the hose arranged between the opened blow mold halves is clampable by the gripping elements without the blow mold halves having to be completely closed.

The advantageous embodiments and claims for the method of the invention have corresponding advantageous applications to the blow mold of the invention.

Preferably, the hose gripper comprises two gripping areas. The respective gripping area is formed by two opposite surfaces, which are movable towards each other, of the two gripping elements. As described, these two gripping areas are spaced apart from each other, so that an inlet opening is formed in the hose, when it is clamped by the hose gripper. Per gripping element, the hose gripper preferably comprises at least one spring. This spring is, as already described, formed as any energy accumulator, for example as a spiral spring or in any other way.

The springs bias the gripping elements towards each other, so that by means of the spring force the gripping elements close to clamp the hose.

Further, the hose gripper comprises holding devices, which are formed to hold the gripping elements in the open, spring-loaded position. These holding devices are, for example, hydraulic or pneumatic cylinders.

Particularly preferably, the holding devices are double-acting cylinders, so that by pressurizing the cylinders accordingly, it is possible for the gripper elements on the one hand for open holding against the spring force and on the other hand for closing supported by the spring force.

In one variant, it is preferably arranged that the gripping areas are movable towards each other to deform the inlet opening. As described, the oval inlet opening can be changed to a rounder opening.

Further details, advantages and features of the present invention will be apparent from the following description of an example embodiment with reference to the drawings.

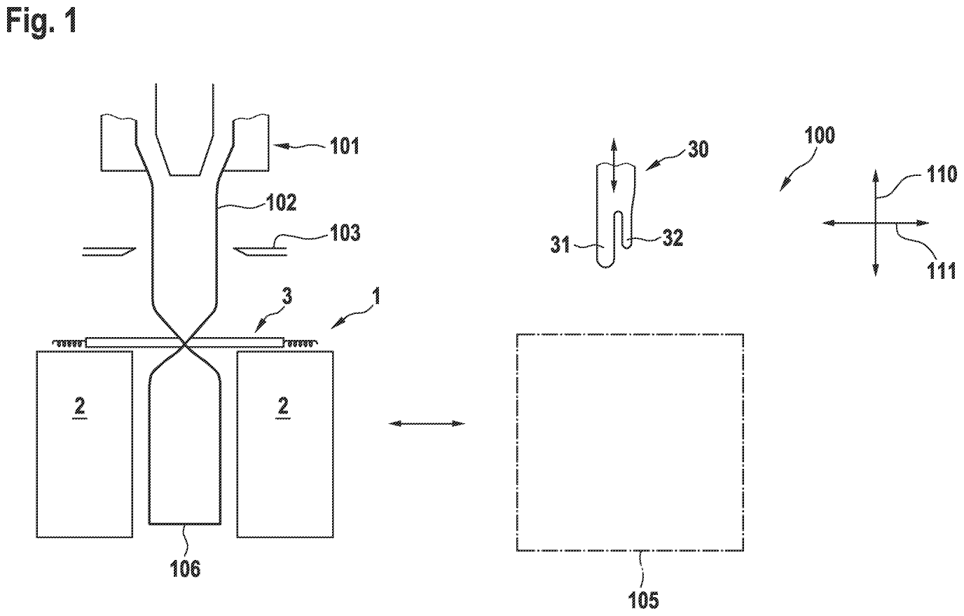

FIG. 1 shows a schematic view illustrating the method of the invention according to an embodiment,

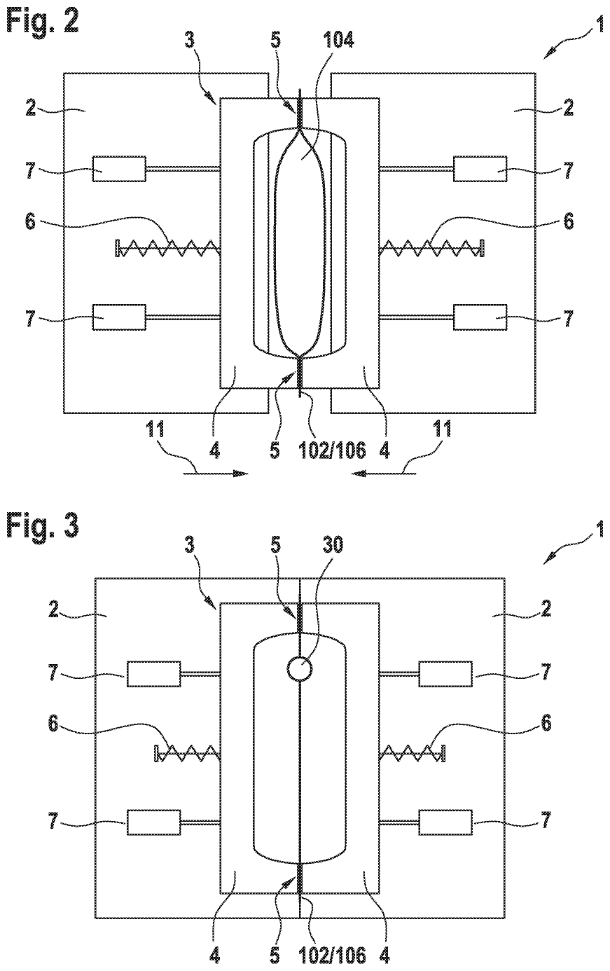

FIG. 2 shows a top view of a blow mold of the invention for carrying out the method of the invention according to the embodiment,

FIG. 3 shows a top view of the closed blow mold of FIG. 2,

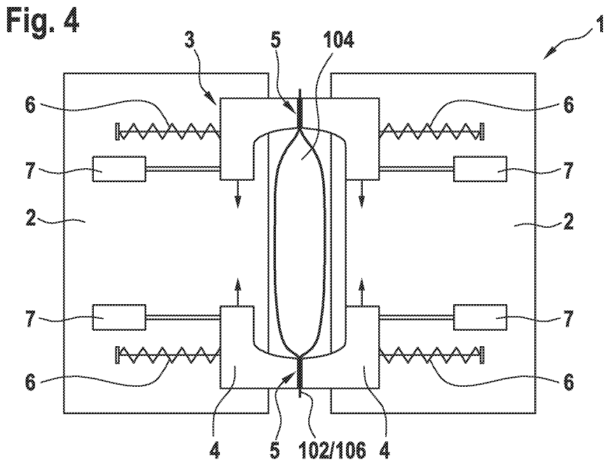

FIG. 4 shows a top view of a variant of the blow mold of FIG. 2,

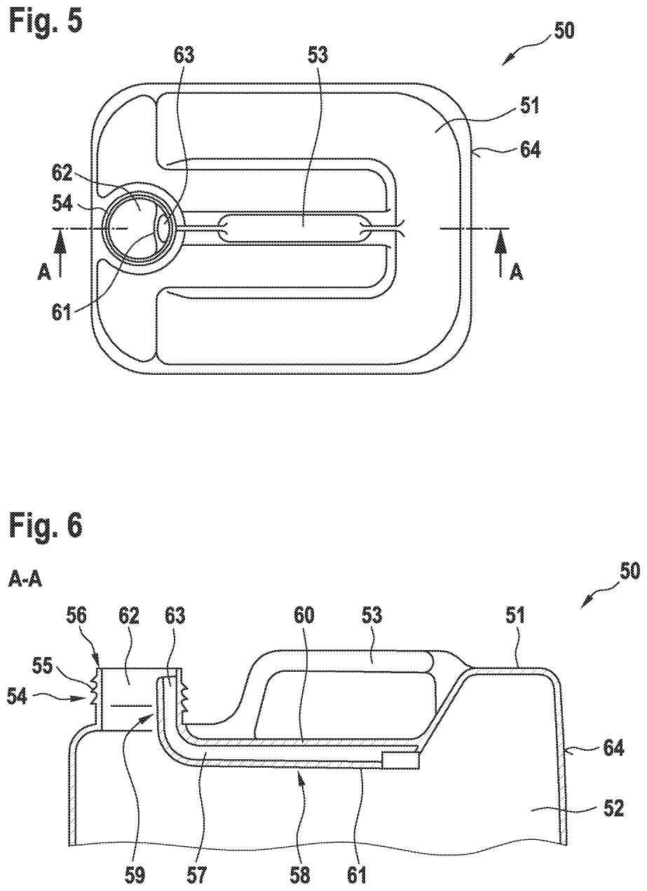

FIG. 5 shows a top view of a container produced by the method of the invention according to the embodiment,

FIG. 6 shows the section A-A indicated in FIG. 5,

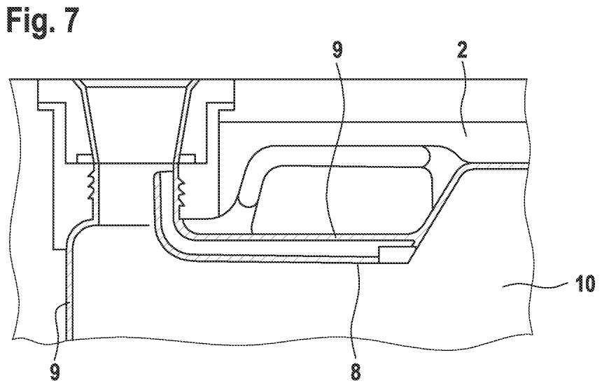

FIG. 7 shows a detailed view of the blow mold of the invention for carrying out the method of the invention according to the embodiment,

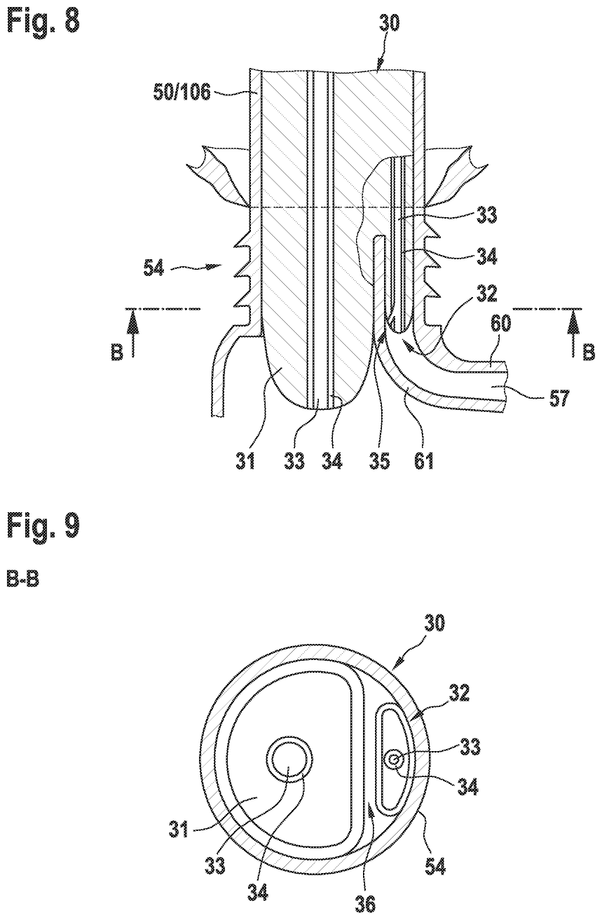

FIG. 8 shows a detailed view of a blow mandrel assembly for carrying out the method of the invention according to the embodiment, and

FIG. 9 shows the section B-B shown in FIG. 8.

The method of the invention for producing a container 50 by using a blow mold 1 according to the invention is explained in detail below with reference to FIGS. 1 to 9. Reference is always made to all figures, unless otherwise mentioned in detail.

FIG. 1 shows an assembly 100, which can be used in carrying out the method. The illustration is merely schematic.

The assembly 100 comprises a blow head 101, with which a hose 102 made of plastic is continuously extruded. The hose 102 thereby hangs downwardly from the blow head 101 along the vertical 110.

Further, the schematic illustration in FIG. 1 shows that the assembly 100 comprises a blow mold 1. This blow mold 1 further comprises two opposite blow mold halves 2. A hose gripper 3 is arranged on these blow mold halves 2.

Above the hose gripper 3 is a cutting device 103 for cutting and simultaneously closing the hose 102.

In the method sequence, the hose 102 is extruded continuously. The blow mold 1 is regularly positioned at the hose 102 with the blow mold halves 2 opened. Further, the blow mold halves 2 are then not closed, but the hose 102 is merely clamped with the hose gripper 3. The hose 102 is then cut off above the blow gripper 3 by the cutting device 103, so that the preform 106 remains hanging between the two blow mold halves 2. Without closing the blow mold halves 2, the blow mold 1 together with the preform 106 hanging therein is moved along the horizontal 111 into a blowing position 105. As a result, the blow mold 1 is no longer located under the continuously further extruding hose 102.

At the blowing position 105, the blow mandrel assembly 30 shown merely schematically in FIG. 1 is inserted into the preform 106 via a movement along the vertical 110. This is followed by closing of the blow mold halves 2 and inflating of the preform 106 to form the container 50, as shown for example in FIGS. 5 and 6.

In the following, the schematic structure of the blow mold 1 is described in detail with reference to FIGS. 2 to 4. FIG. 2 shows a top view of the opened blow mold 1. FIG. 3 shows a top view of the closed blow mold 1. FIG. 4 shows a top view of an alternative form of the blow mold 1, illustrated in the opened state.

As already described, the blow mold 1 comprises two blow mold halves 2 and a hose gripper 3. The hose gripper 3 further comprises two gripping elements 4. On each blow mold half 2, a gripping element 4 is arranged on the upper side. Each gripping element 4 is movable along the horizontal 111 parallel to the mold closing direction 11 relative to the blow mold halves 2. In FIGS. 2 to 4, the hose gripper 3 is closed. The two opposite gripping elements 4 have moved towards each other. The preform 106 is clamped at two spaced gripping areas 5. As the two gripping areas 5 are spaced apart from each other, an inlet opening 104 remains in the preform 106 between the two gripping areas 5. The blow mandrel assembly 30 can be inserted through this inlet opening 104 at the blowing position 105, before the blow mold halves 2 are closed along the mold closing direction 11.

FIGS. 2 to 4 show merely schematically that the gripping elements 4 are biased in the direction of their closed position by means of springs 6. These springs 6 press the gripping elements 4 toward each other. By means of holding devices 7, for example formed as pneumatic or hydraulic cylinders, the gripping elements 4 can be held in their open position against the spring force.

FIG. 3 shows a top view of blow mold 1 in the closed position. The blow mold halves 2 are completely closed. As a result, the inlet opening 104 is closed. The blow mandrel assembly 30 protrudes into the preform 106 from above.

FIG. 4 shows a variant, in which the gripping elements 4 on the corresponding blow mold halves 2 are designed in two parts. The gripping elements 4 are movable towards each other in such a way that the gripping areas 5 are movable towards each other. This allows the oval form of the inlet opening 104 to be changed to a rounder form.

FIG. 5 shows a top view of the container 50 produced by the assembly 100 or rather the blow mold 1. FIG. 6 shows the section A-A indicated in FIG. 5.

Accordingly, the container 50 comprises an upper wall 51 and an opposite, not shown, bottom. The upper wall 51 and the bottom are connected via a circumferential surface 64 of the container 50. Thus, the upper wall 51, bottom and circumferential surface 64 form an inner space 52 of the container 50 for holding a liquid.

A handle 53 is formed at the upper wall 51. In front of the handle 53 is a spout 54 formed for pouring the liquid into and out of the inner space 52.

The spout 54 ends with an upper end 56. This upper end 56 is sealed by a cover, not shown, which can be screwed onto an external thread 55 of the spout 54.

Further, a venting channel 57 is located on the inner side of the top panel 51. The venting channel 57 is divided into a horizontal portion 58 and a vertical portion 59.

The venting channel 57 is formed by an outer channel wall 60 and an inner channel wall 61. The inner channel wall 61 is formed preferably through squeezing of the preform 106. Squeezing edges 8 (see FIG. 7) are used on the blow mold halves 2 for this purpose. The outer channel wall 60 is preferably an outer wall of the container 50.

The venting channel 57 protrudes with its vertical portion 59 into the spout 54. From the spout 54, the vertical portion 59 extends downward and merges into the horizontal portion 58. The horizontal portion 58 extends into the rear region of the container 50 and opens into the inner space 52. The horizontal portion 58 does not have to run exactly horizontally, but can also run in an inclined manner

By virtue of the fact that the venting channel 57 extends into the spout 54, the inner channel wall 61 divides the inner space of the spout 54 into a main opening 62, through which the liquid passes during pouring in and out, and a venting opening 63. It is preferably arranged that the venting opening 63 is substantially smaller in cross-section than the main opening 62. Preferably, the cross-sectional area of the venting opening 63 is at most 25%, preferably at most 20%, of the cross-sectional area of the main opening 62.

FIG. 7 shows an area of one of the two blow mold halves 2. It can be seen that the corresponding part of the mold cavity 10 is formed in the blow mold halves 2. Cutting edges 9 run around the mold cavity 10, which together with the cutting edges of the other blow mold halves 2 close and cut off the preform 106.

Further, FIG. 7 shows that the blow mold halves 2 respectively comprise a squeezing edge 8 that squeezes the preform 106 to form the inner channel wall 61. These squeezing edges 8 extend corresponding to the vertical portion 59 of the venting channel 57 also in the area of the spout 54.

FIG. 8 shows how the blow mandrel assembly 30 is inserted into the container 50. FIG. 9 shows the section B-B indicated in FIG. 8.

The blow mandrel assembly 30 comprises a main blow mandrel 31 and an ancillary blow mandrel 32. The main blow mandrel 31 is arranged in the area of the spout 54, when the blow mold halves 2 are closing and when the container 50 is inflated, and is thereby formative for the inside of the main opening 62. At the same time, the ancillary blow mandrel 32 is also arranged in the area of the spout 54, when the blow mold halves 2 are closed and when the container 50 is inflated, and is thereby formative for the inner surface of the venting opening 63 or rather of the vertical portion 59 of the venting channel 57.

As shown in section B-B in FIG. 9, the main blow mandrel 31 and the ancillary blow mandrel 32 are spaced apart from each other by a squeezing edge gap 36. Since the blow mandrel assembly 30 is already arranged in place when the blow mold halves 2 are closed, the two squeezing edges 8 squeeze the material into the squeezing edge gap 36. Through the corresponding position of the ancillary blow mandrel 32, no material is thereby squeezed into the venting channel 57 to be created, preferably the vertical portion 59.

The two blow mandrels 31, 32 each comprise a centric blow channel 33 for blowing compressed air into the inner space 52. A return flow channel 34 is respectively arranged around the blow channel 33.

Merely schematically, FIG. 8 shows that the ancillary blow mandrel 32 can comprise an inclined compressed air outlet 35 or several of these inclined compressed air outlets 35 on its underside. Air is blown out through this compressed air outlet 35 inclined to the vertical 110. This allows any material squeezed into the emerging venting channel 57 to be blown away, thereby facilitating the desired cross-sectional area of the venting channel 57.

Further, preferably at least one of the gripping elements 4 comprises a compressed air nozzle, which enables the preform 106 to be pre-blown, before the blow mold halves 2 are closed.

### LIST OF REFERENCE SIGNS

1 blow mold

2 blow mold halves

3 hose gripper

4 gripping element

5 gripping areas

6 springs

7 holding device

8 squeezing edge

9 cutting edge

10 mold cavity

11 mold closing direction

30 blow mandrel assembly

31 main blow mandrel

32 ancillary blow mandrel

33 blow channel

34 return flow channel

35 inclined-arranged compressed air outlet

36 squeezing edge gap

50 container

51 upper bottom

52 inner space

53 handle

54 spout

55 external thread

56 upper closure

57 venting channel

58 horizontal portion

59 vertical portion

60 outer channel wall

61 inner channel wall

62 main opening

63 venting opening

64 circumferential surface

100 assembly

101 blow head

102 hose

103 cutting device

104 inlet opening

105 blowing position

106 preform

110 vertical

111 horizontal

1. A method of manufacturing a container made of plastic, comprising the following steps:
continuously extruding a hose,
positioning an opened blow mold around the hose so that the hose is arranged between two blow mold halves,
closing a hose gripper arranged at the blow mold to clamp the hose and simultaneously holding the hose open at its upper side to form an inlet opening,
separating the hose above the hose gripper to form a preform,
horizontally moving the blow mold together with the preform hanging therein and held by the hose gripper in a blowing position,
inserting a blow mandrel assembly from above into the inlet opening of the preform,
closing the blow mold halves, and
inflating the preform in the blow mold to form a container.
wherein the hose gripper clamps the hose with two gripping areas at two locations spaced apart from each other, so that the inlet opening comprises an oval cross-section.

2. Method according claim 1, wherein the hose gripper comprises at least one gripping element on each blow mold half.

3. Method according to claim 2, wherein the at least one gripping element is spring-loaded in a closing direction via springs.

4. Method according to claim 1, wherein when the hose is clamped the two gripping areas are moved towards each other to deform the inlet opening.

5. Method according to claim 1,
wherein the container comprises a spout for pouring into and out of the container.

6. Method according to claim 1, wherein compressed air is injected into the preform for pre-blowing the preform before the blow mold halves are closed.

7. Method according to claim 6, wherein the preform is inflated beyond an inner mold dimension of the blow mold during pre-blowing.

8. Method according claim 1, wherein the blow mandrel assembly is moved horizontally after inserting into the inlet opening and before closing the blow mold halves.

9. Method according to claim 5, wherein the blow mandrel assembly comprises at least one compressed air outlet arranged inclined at its lower side and, when the container is inflated, material is blown away via the compressed air outlet to define a venting channel.

10. A blow mold for manufacturing a container made of plastic, comprising:
two blow mold halves, forming the container,
and a hose gripper with at least one gripping element on an upper side of one blow mold half and at least one opposite gripping element on an upper side of another blow mold half,
wherein the gripping elements are movable relative to the blow mold half, so that a hose arranged between opened blow mold halves is clampable by the gripping elements without closing the blow mold halves.
wherein the hose gripper includes two gripping areas, each of which is for clamping the hose, and wherein the two gripping areas are spaced apart from each other to form an inlet opening with oval cross-section in the hose.

11. Blow mold according to claim 10, comprising at least one spring per gripping element which biases the gripping element in a closing direction.

12. Blow mold according to claim 10, wherein the two gripping areas are movable towards each other for deforming the inlet opening.

13. Blow mold according to claim 10, further comprising a holding device which is configured to hold and release the gripping element.

14. Blow mold according to claim 11, further comprising a holding device which is configured to hold and release the gripping element.

15. Method according to claim 1, wherein the hose is clampable between the at least one gripping element on each blow mold half.

16. Method according to claim 3, wherein the springs are relaxed to clamp the hose.

17. Method according to claim 3, wherein the springs are tensioned during closing of the blow mold halves.

18. Method according to claim 3, wherein the springs are held in a tensioned state during opening of the blow mold halves.

19. Method according to claim 5, wherein a vertical portion of a venting channel of the container protrudes into the spout.

20. Method according to claim 19, wherein the blow mandrel assembly forming with a main blow mandrel the spout and forming with an ancillary blow mandrel the vertical portion of the venting channel when the blow mold halves are closing.
